(19) United States
(12) Patent Application Publication
(10) Pub. No.: US 2017/0163990 A1
(43) Pub. Date: Jun. 8, 2017

(54) VIDEO TRANSCODING METHOD AND SYSTEM

(71) Applicants: LE HOLDINGS (BEIJING) CO., LTD., Beijing (CN); LECLOUD COMPUTING CO., LTD., Beijing (CN)

(72) Inventors: Chao LV, Beijing (CN); Wei WEI, Beijing (CN); Maosheng BAI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/247,610

(22) Filed: Aug. 25, 2016

Related U.S. Application Data
(63) Continuation of application No. PCT/CN2016/088713, filed on Jul. 5, 2016.

(30) Foreign Application Priority Data
Dec. 7, 2015 (CN) 201510890653.6

(51) Int. Cl. H04N 19/176; H04N 19/139; H04N 19/13; H04N 19/124

(52) U.S. Cl. CPC H04N 19/176; H04N 19/124; H04N 19/139; H04N 19/13

(57) ABSTRACT

The present embodiments disclose a video transcoding method and system, wherein, decodes an inputting code stream by a GPU to obtain a decoded inputting code stream; analyze the decoded inputting code stream by a CPU to obtain a marco block information required in encoding; encode the decoded inputting code stream in a target bit rate by the CPU according to the marco block information required in encoding. Use the GPU to decode for saving resources of the CPU, code stream analyze a decode stream at the same time, improve an overall transcoding speed without affecting a transcode quality at the same time, save transcode CPU resources.

### CROSS REFERENCE TO RELATED APPLICATIONS

This application is a continuation of International Application No. PCT/CN2016/088713, filed on Jul. 5, 2016, which is based upon and claims priority to Chinese Patent Application No. 201510890653.6, filed on Dec. 7, 2015, the entire contents of which are incorporated herein by reference.

### TECHNICAL FIELD

The disclosure relates to an internet video process technology, particularly regarding to a video transcode method and system.

### BACKGROUND

With the current developments of internet video and hardware device, the cost for video producing by people has become lower, and the requirements on video quality has become higher. The resolution of the video has become higher, and the high-definition (HD, 1080P, 1920×1080) or even the 4K ultra-high definition (4K, 3840×2160) have become common. For the video transcode industry, the video transcode pressure has become larger. In the direct broadcasting of the high resolution video, when offline transcoding, transcode server is often under the high loading. How to use the hardware resources on the transcode server more efficiently to improve the transcode speed is a common topic in the industry.

### SUMMARY

According to this, this disclosure provides a video transcode method and device, system, which can use a graphical processing unit (GPU) to decode for saving resources of a central process unit (CPU), code stream analyzing a decode stream at the same time, improve an overall transcoding speed without affecting a transcode quality at the same time, saving transcode CPU resources. This disclosure also provides a video transcode device.

An embodiment of the present disclosure provides a video transcoding method, includes:

decoding an inputting code stream by a graphical processing unit to obtain a decoded inputting code stream;

analyzing the decoded inputting code stream by the central processing unit to obtain a marco block information required in encoding;

encoding the decoded inputting code stream in a target bit rate by the central processing unit according to the marco block information required in encoding.

Wherein, decoding an inputting code stream by a graphical processing unit, includes:

determining whether the graphical processing unit supports the decoding of the inputting code stream; if yes, acquire a decoding capability information of the graphical processing unit;

send the inputting code stream to the graphical processing unit through a decoding pin corresponding to the decoding capability information to decode.

Wherein, before decoding an inputting code stream by a graphical processing unit, includes:

initializing a codec parameter of the graphical processing unit according to the decoding pin corresponding to the decoding capability information, and distribute memory space for the inputting code stream waiting for decoding, the memory space is for saving the inputting code stream which is decoded.

Wherein, analyzing a decoded inputting code stream by the central processing unit to obtain a marco block information required in encoding, includes:

analyzing a header information of the decoded inputting code stream by the central processing unit to obtain an entropy encoding type;

entropy decoding the decoded inputting code stream, during the entropy decoding, discard all decoded residual information, and recording information required in encoding, wherein the marco block information required in encoding includes a block type information, a block mode information, a motion vector information, a coded block pattern information, a quantization parameter, and a residual marco block, etc. which are required information for encoding.

An embodiment of the present disclosure provides a video transcoding system including: a decoder and an encoder;

the decoder, for decoding an inputting code stream by a graphical processing unit (GPU) to obtain a decoded inputting code stream;

the encoder, for analyzing the decoded inputting code stream by a central processing unit (CPU) to obtain a marco block information required in encoding; encoding the decoded inputting code stream in a target bit rate by the central processing unit (CPU) according to the marco block information required in encoding.

Wherein, the decoder is also used for determining whether the graphical processing unit supports the decoding of the inputting code stream; if yes, acquiring a decoding capability information of the graphical processing unit; initializing a codec parameter of the graphical processing unit according to the decoding pin corresponding to the decoding capability information, and distributing memory space for the inputting code stream waiting for decoding, wherein the memory space is for saving the inputting code stream which is decoded; transmitting the inputting code stream to the graphical processing unit through a decoding pin corresponding to the decoding capability information to decode;

the encoder, also for analyzing a header information of the decoded inputting code stream by the central processing unit to obtain an entropy encoding type; entropy decoding the decoded inputting code stream, during the entropy decoding, discarding all decoded residual information, and recording information required in encoding, wherein the marco block information required in encoding includes a block type information, a block mode information, a motion vector information, a coded block pattern information, a quantization parameter, and a residual marco block which are required information for encoding.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a video transcode method in accordance with an embodiment of the present disclosure;

FIG. 2 is a flow chart of a CPU and GPU mixing transcode structure in accordance with an embodiment of the present disclosure;

FIG. 3 is a flow chart of an accomplishment of a video decoding on a GPU in accordance with an embodiment of the present disclosure;

FIG. 4 is a flow chart of an accomplishment of a code stream analyzing on a CPU in accordance with an embodiment of the present disclosure;

FIG. 5 is a structural schematic view of a video transcoding device in accordance with an embodiment of the present disclosure; and

FIG. 6 is a structural schematic view of a video transcoding electronic apparatus in accordance with an embodiment of the present disclosure.

### DETAILED DESCRIPTION

The primary idea of the present disclosure is about based on a GPU and CPU mixing transcode structure, use a graphical processing unit (GPU) to decode for saving resources of a central process unit (CPU), code stream analyzing a decode stream at the same time, improve an overall transcoding speed without affecting a transcode quality at the same time, saving transcode CPU resources.

For the purpose, technical solutions, and advantages of the present disclosure will become clearer, the followings combine figures and particular embodiments of the present disclosure to further described the present disclosure in detail. In a typical configuration, a computing device includes one or more processors (CPU), input/output interfaces, network interfaces, and memory.

The memory may include a computer-readable medium volatile memory, random access memory (RAM) and / or other forms of nonvolatile memory, such as read only memory (ROM) or Flash memory (flash RAM). The memory is an example of the computer-readable memory medium.

Computer-readable media includes both permanent and non-permanent, removable and non-removable media may achieve information storage in any method or technology. Information can be computer-readable instructions, data structures, program modules or other data. Examples of computer storage media include, but are not limited to, phase change memory (the PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storage, magnetic tape cassette, magnetic disk storage or other magnetic tape storage devices, or any other magnetic non-transmission medium, it may be used to store the information can be computing device access. Defined in accordance with this article, a computer-readable medium does not include short-term computer-readable media (transitory media), such as a modulated data signal and the carrier wave.

As used in the specification and claims which certain terms are used to refer to a specific component. Skilled in the art will appreciate, manufacturers may use different terms to refer to the same component. This specification and the claims are not to be differences in the names of the components as a way to distinguish, but the difference in a component to function as a criterion to distinguish. As mentioned throughout the specification and claims, and among “comprising” is an open-ended term, it should be interpreted to mean “including, but not limited to. “Approximately” means within an acceptable error range, those skilled in the art to solve the problem within a certain error range, to achieve the basic technical effect. In addition, “coupled” as used in this is included with any direct and indirect electrical connection means. Therefore, if the paper describes a first device is coupled to a second device, the first device may represent a direct electrical connection to the second device, or connected to the second device through other means or indirectly electrically connecting means. The following descriptions in the specification are the preferred embodiment of the present disclosure, and the purpose of the description are the general principles of this disclosure but not intended to limit the scope of the disclosure. When the scope of the disclosure depends on the appended claims and their equivalents.

It is further noted that the term “comprising”, “including” or any other variation thereof, are intended to cover a non-exclusive inclusion, such that a series of factors including the process, method, merchandise or system includes not only those elements, but also include other elements not expressly listed or for such further comprising process, method, or system merchandise inherent feature. Without more constraints, by the statement “includes a . . . ” defined elements, does not exclude the existence of additional identical elements in the process include the elements, methods, goods or system.

The inventors discovered in the implement of the present disclosure:

with the continuous increase of the video resolution and rate, the complexity of the video decoding is also increased continuously, the system resource correspondingly occupied by the computing of the video decode is also continuously increased. The video decoding (soft decoding) exploited by the CPU occupies a great amount of the CPU computing resource, and CPU computing resource might even cannot fulfill the requirements of the high resolution and the high rate.

The present disclosure provides a new video transcode system structure, primary applies on transcode programs such as H.264, HEVC, etc. The conventional transcode programs often totally base on the using the CPU resource, in the high resolution and high quality transcoding process, a loading of the CPU resource is often too large, and influences the transcoding speed. An feature of the transcode system structure in an embodiment of the present disclosure is the job of a video decoding is accomplished by the GPU in a transcoding process, only the part of an analyzing of decoded information is accomplished by the CPU, to relieve the CPU computing resource by effectively using the GPU, therefore improves the overall transcoding speed.

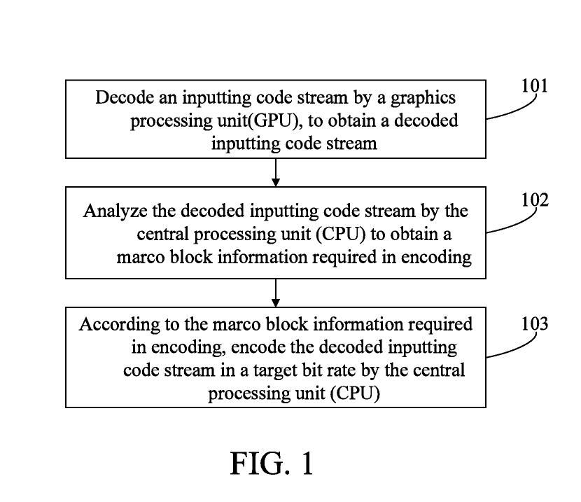

FIG. 1 is a flow chart of a video transcode method in accordance with an embodiment of the present disclosure, as shown in FIG. 1, include:

Step 101: decode an inputting code stream by a GPU; to obtain a decoded inputting code stream;

In an embodiment, an concrete implementation of the step 101 includes:

first, determine whether the graphical processing unit supports the decoding of the inputting code stream; if yes, acquire a decoding capability information of the GPU;

according to the decoding pin corresponding to the decoding capability information, initialize a codec parameter of the graphical processing unit and distributing memory space for the inputting code stream waiting for decoding;

transmit the inputting code stream to the graphical processing unit through a decoding pin corresponding to the decoding capability information to decode;

save the decoded inputting code stream to the distributed memory space.

Wherein, determining whether the graphical processing unit supports the decoding of the inputting code stream in the above step, when a video waiting for decoding needs to be decoded, an disclosure can establish a connection with a GPU driver procedure through the system procedure (such as windows operating system). Specifically, the disclosure generates a DXVA output pin, and use DXVA Output Pin to connect IAM Video Accelerator Input Pin (a pin provided by windows for disclosure to connect the GPU driver procedure, which can also be called as GPU driver connection pin, belongs to a kind of DXVA pin) of the Video Mixing Renderer (VMR), and generate a corresponding filter graph (a combination of multiple filters, which multiple filters are connected together, to accomplish specific functions such as video playing and video acquiring). After the disclosure can establish a connection with the GPU driver procedure, can confirm the decoding capability information of the GPU to the driver procedure, after the driver procedure receiving the confirm command, transmit the decoding capability information of the GPU to the driver procedure, such as the decoding capability information of the GPU includes DXVA_ModeH261_B, DXVA_ModeH263_B, DXVA_ModeMPEG1_A, DXVA_ModeMPEG2_B, etc.

When the decoding capability information of supporting the encode format of the video waiting for decoding exist in the decoding capability information acquired, the disclosure continue to confirm whether the GPU in a working mode corresponding to the decoding capability information supports a decode configuration information of the video waiting for decoding, if yes, then provide a confirmation result that the GPU can support the decoding of the video waiting for decoding. When the decoding capability information of supporting the encode format of the video waiting for decoding does not exist in the decoding capability information acquired, or confirm the GPU in a working mode corresponding to the decoding capability information does not supports a decode configuration information of the video waiting for decoding, then provide a confirmation result that the GPU cannot support the decoding of the video waiting for decoding. Specifically, the disclosure can acquire the encode format and the decode configuration information of the video from the video file waiting for decoding, the encode format can include H.261, H.263, H.264, MPEG2, etc., the decode configuration information can include the information of the resolution, the rate, the cached video frames, the color space format, etc. Specifically, the disclosure looks for the decoding capability information which can support the encode format of the video waiting for decoding in the decoding capability information reported by the driver procedure, if it can find it, then further transmits the decoding capability information and the decode configuration information of the video waiting for decoding to the GPU driver procedure to confirm whether the GPU can support the corresponding decode configuration at the corresponding working mode.

For example (the decode configuration information here takes only the resolution and the rate as the example to explain), the encode format of some video is H261, the resolution is 1280×720, the rate is 2000 kbps, and assume the GPU supports the working mode of the DXVA_ModeH261_B, and can maximally support the resolution of 1280×720, the rate of 3000 kbps at the working mode. the video player find the DXVA_ModeH261_B in the decoding capability information reported by the driver procedure, transmit the DXVA_ModeH261_B, 1280×720, and 2000 kbps to the driver procedure, to confirm whether the GPU supports the resolution of 1280×720 and the rate of 2000 kbps at the working mode of the DXVA_ModeH261_B, the driver procedure return the “support” information.

Step 102: analyze the decoded inputting code stream by the central processing unit to obtain a marco block information required in encoding;

Specifically, an concrete implementation of the step 102 includes:

analyze a header information of the decoded inputting code stream by the central processing unit to obtain an entropy encoding type;

entropy decode the decoded inputting code stream, during the entropy decoding, discard all decoded residual information, and record information required in encoding, wherein the marco block information required in encoding includes a block type information, a block mode information, a motion vector information, a coded block pattern (CBP) information, a quantization parameter, and a residual marco block, etc. which are required information for encoding. The marco block encode mode includes the block type information, the block mode information, and the motion vector information.

Step 103: according to the marco block information required in encoding, encode the decoded inputting code stream in a target bit rate by the central processing unit (CPU).

The following takes specific concrete implementations as examples to describe the technique feature of the present disclosure in detail:

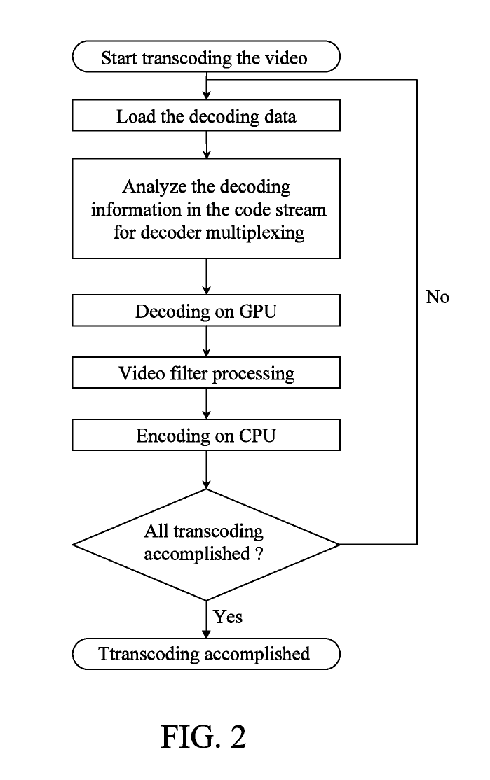

FIG. 2 is a flow chart of a CPU and GPU mixing transcode structure in accordance with an embodiment of the present disclosure, as shown in FIG. 2, the transcode structure has two main improvements: first, the decode of the video is accomplished at the GPU; second, the analyzing and the saving of the information of the decoded video are accomplished on the CPU.

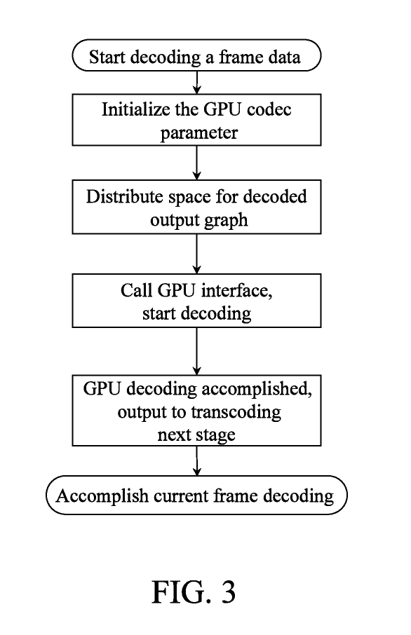

To invoke the GPU for video decoding, first, choose to use a server supporting the video decoding by the GPU, such as sever E3-1285 of Intel. FIG. 3 is a flow chart of an accomplishment of a video decoding on a GPU in accordance with an embodiment of the present disclosure, as shown in FIG. 3, after the transcoding starts operating, when the inputting code stream arrives the decoding terminal, firstly, the decoder needs to initialize the GPU codec parameter, and distribute the memory space for the current video frame. When initializing the GPU parameter, the requirements of an interface call corresponding to the GPU decoding module has to be considered to choose an appropriate apparatus. The distributing of the space has to fulfill the requirements of the GPU decoding: the space has to be 32-bytes alignment, brightness and color difference space have to be continuous therebetween. If taking the method of distributing the memory space by the GPU apparatus, an appropriate setting has to be made initializing the GPU. After finishing, can decode the current video frame through calling the pin of the video decoding of the GPU. At this time, the decoding process only occupies the GPU resource but not occupies any CPU resource. When the GPU decoding is finished, the decoded video frame is filled into the memory space pre-distributed before, at this point, the GPU decoding of one video frame is accomplished. After this, the decoded video frame is output to the downstream, and the next step of the co-transcoding structure is to be continually executed.

Since the decoding procedure is executed on the GPU, the detailed decoding information of the inputting code stream cannot be stored, so the transcoding structure has to add one analyze module, for analyzing and storing the codec parameter in the inputting code stream, for the following encoder to multiplex. The analyzing module is operated on the CPU, only response to the data stream analyzing, no deeper layer decoding, and without large memory operation, so the speed is far faster than the decoding.

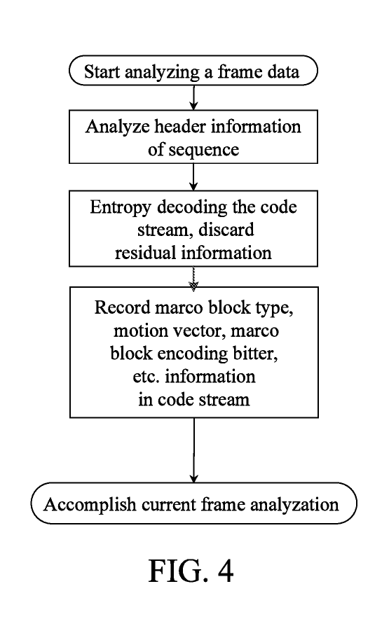

FIG. 4 is a flow chart of an accomplishment of a code stream analyzing on a CPU in accordance with an embodiment of the present disclosure, as shown in FIG. 4, firstly, analyze a header information of the inputting code stream to obtain an entropy encoding type. Next, to obtain more specific data stream information, process the entropy decoding to the data stream. During the entropy decode procedure, discard all decoded residual information, only record the information such as the marco block type, the motion vector, the marco block encoding bitter, etc. These information will be provided to the encoder to multiplex.

The present disclosure provides a transcode structure based on mixing the GPU and the CPU, primary applies on transcode programs such as H.264, HEVC, etc. Use a graphical processing unit (GPU) to decode for saving resources of a central process unit (CPU), and code stream analyze the decoded code stream at the same time, improve an overall transcoding speed without affecting a transcode quality at the same time, save transcode CPU resources. The transcode structure can save 10% CPU resource comparing with the conventional transcode structure, thereby ensure a premise of restoration of a video quality, improves the transcode speed, to better meet the requirements of real-time video transcode.

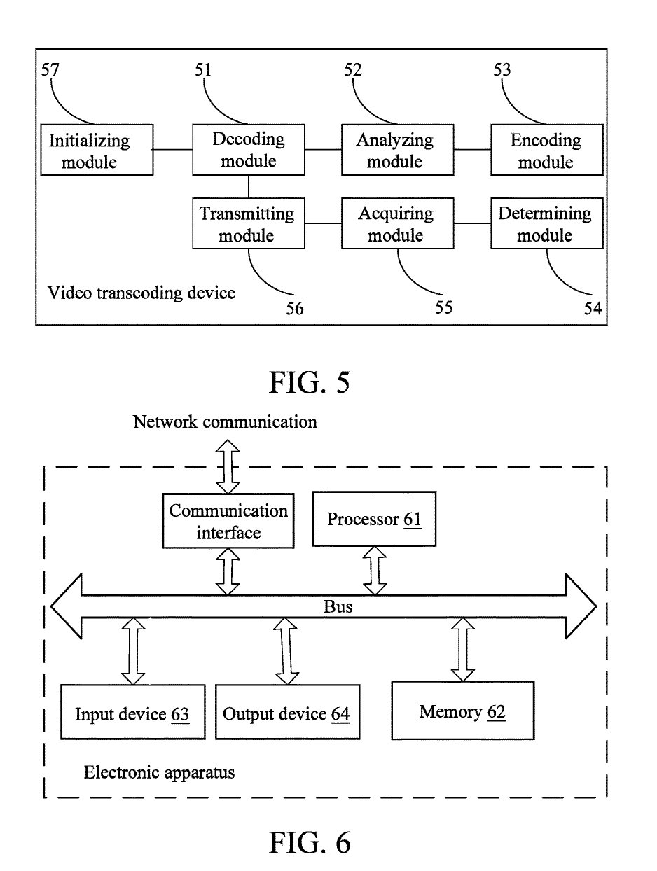

FIG. 5 is a structural schematic view of a video transcoding device in accordance with an embodiment of the present disclosure, as shown in FIG. 5, includes:

a decoding module 51 located at a graphical processing unit side for decoding an inputting code stream to obtain a decoded inputting code stream;

an analyzing module 52 located at a central processing unit side for analyzing the decoded inputting code stream to obtain a marco block information required in encoding;

an encoding module 53 located at the central unit side for encoding the decoded inputting code stream in a target bit rate by the central processing unit according to the marco block information required in encoding.

Wherein, the device further includes:

a determining module 53 for determining whether the GPU supports the decoding of the inputting code stream;

an acquiring module 54 for acquiring a decoding capability information of the GPU when the determining module confirms the GPU can support the decoding of the inputting code stream;

a transmitting module 55 for transmitting the inputting code stream to the GPU through a decoding pin corresponding to the decoding capability information to decode.

The device further includes:

an initializing module 56 for initializing a codec parameter of the GPU according to the decoding pin corresponding to the decoding capability information, and distributing memory space for the inputting code stream waiting for decoding, wherein the memory space is for saving the inputting code stream which is decoded.

Wherein, the analyzing module 52 is specifically for:

analyzing a header information of the decoded inputting code stream by the CPU to obtain an entropy encoding type;

entropy decoding the decoded inputting code stream, during the entropy decoding, discarding all decoded residual information, and recording information required in encoding, wherein the marco block information required in encoding includes a block type information, a block mode information, a motion vector information, a coded block pattern information, a quantization parameter, and a residual marco block, etc., which are required information for encoding.

The device shown in FIG. 5 can exploit the method shown in FIG. 1, and the principle and technical effects will not be repeated hereafter.

An embodiment of the present disclosure provides a video transcoding system, wherein, including: a decoder and an encoder;

the decoder, for decoding an inputting code stream by a graphical processing unit to obtain a decoded inputting code stream;

the encoder, for analyzing the decoded inputting code stream by a central processing unit to obtain a marco block information required in encoding; encoding the decoded inputting code stream in a target bit rate by the central processing unit according to the marco block information required in encoding.

The decoder is also for determining whether the GPU supports the decoding of the inputting code stream; if yes, acquiring a decoding capability information of the graphical processing unit; initializing a codec parameter of the graphical processing unit according to the decoding pin corresponding to the decoding capability information, and distributing memory space for the inputting code stream waiting for decoding, wherein the memory space is for saving the inputting code stream which is decoded; transmitting the inputting code stream to the graphical processing unit through a decoding pin corresponding to the decoding capability information to decode.

The encoder is also for analyzing a header information of the decoded inputting code stream by the CPU to obtain an entropy encoding type; entropy decoding the decoded inputting code stream, during the entropy decoding, discarding all decoded residual information, and recording information required in encoding, wherein the marco block information required in encoding includes a block type information, a block mode information, a motion vector information, a coded block pattern information, a quantization parameter, and a residual marco block, etc. which are required information for encoding.

The system in the embodiment of the present disclosure can exploit the method shown in FIG. 1, and the principle and technical effects will not be repeated hereafter.

The above description shown and described several preferred embodiments of the present disclosure, as previously discussed, it should be understood that the disclosure is not limited to the form disclosed herein and should not be regarded as exclusion of other embodiments, and can be applied in various other combinations, modifications, and environments, and can be conceived within the scope of the disclosure described herein, and can make changes according to the above teachings, technology or knowledge in related fields. Modifications and variations carried out by staff in this field without departing from the spirit and scope of the present disclosure should be within the scope of the claims of the present disclosure.

An embodiment of the present disclosure provides a non-volatile computer storage medium. The computer storage medium stores computer-executable instructions, and the computer-executable instructions can carry out the video transcoding method in any one of the method embodiments.

FIG. 6 is a structural schematic view of a video transcoding electronic apparatus in accordance with an embodiment of the present disclosure, as shown in FIG. 6, the apparatus including:

one or multiple processor 61 and a memory 62. The number of the processor 61 is one in FIG. 6 as an example.

The video transcoding electronic apparatus can further include: an input device 63 and an output device 64.

The processor 61, the memory 62, the input device 63 and the output device 64 can be connected to each other via a bus or other members for electrical connection. In FIG. 6, they are connected to each other via the bus in this embodiment.

The memory 62 is one kind of non-volatile computer-readable storage mediums applicable to store non-volatile software programs, non-volatile computer-executable programs and modules; for example, the program instructions and the function modules corresponding to the video transcoding method in the embodiments of the present disclosure. The processor 61 executes function disclosures and data processing of the server by running the non-volatile software programs, non-volatile computer-executable programs and modules stored in the memory 61, and thereby the video transcoding method in the aforementioned embodiments are achievable.

The memory 62 can include a program storage area and a data storage area, wherein the program storage area can store an operating system and at least one disclosure program required for a function; the data storage area can store the data created according to the usage of the video transcoding apparatus. Furthermore, the memory 62 can include a high speed random-access memory, and further include a non-volatile memory such as at least one disk storage member, at least one flash memory member and other non-volatile solid state storage member. In some embodiments, the memory 62 can have a remote connection with the processor 61, and such remote-memory can be connected to the video transcoding apparatus by a network. The aforementioned network includes, but not limited to, internet, intranet, local area network, mobile communication network and combination thereof.

The input device 63 can receive digital or character information, and generate a key signal input corresponding to the user setting and the function control of the video transcoding apparatus. The output device 64 can include a displaying unit such as screen.

The one or more modules are stored in the memory 62. When the one or more modules are executed by one or more processor 61, the video transcoding method disclosed in any one of the embodiments is performed.

The aforementioned product can execute the method provided in the embodiment of the present disclosure, having the function modules and beneficial effects corresponding to execute the method. The technical details which are not clearly described in this embodiment can be referred to the method provided in the embodiments of the present disclosure.

The electronic apparatus in the embodiments of the present disclosure is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatuses: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The technical solution of this apparatus, the function effect and connection way of each module are corresponding to the features and technical solutions of the embodiments of FIG. 1 to FIG. 4, the inadequacies can be found in the corresponding embodiments in FIG. 1 to FIG. 4.

What is claimed is:

1. A video transcoding method, applied on a terminal, comprising:
decoding an inputting code stream by a graphical processing unit to obtain a decoded inputting code stream;
analyzing the decoded inputting code stream by a central processing unit to obtain a marco block information required in encoding;
encoding the decoded inputting code stream in a target bit rate by the central processing unit according to the marco block information required in encoding.

2. The method according to claim 1, wherein the decoding the inputting code stream by the graphical processing unit comprises:
determining whether the graphical processing unit supports the decoding of the inputting code stream; if yes, acquiring a decoding capability information of the graphical processing unit;
transmitting the inputting code stream to the graphical processing unit through a decoding pin corresponding to the decoding capability information to decode.

3. The method according to claim 1, before decoding the inputting code stream by the graphical processing unit, comprising:
initializing a codec parameter of the graphical processing unit according to the decoding pin corresponding to the decoding capability information, and distributing memory space for the inputting code stream waiting for decoding, wherein the memory space is for saving the inputting code stream which is decoded.

4. The method according to claim 3, wherein the analyzing the decoded inputting code stream by the central processing unit, to obtain the marco block information required in encoding comprises:
analyzing a header information of the decoded inputting code stream by the central processing unit to obtain an entropy encoding type;
entropy decoding the decoded inputting code stream, during the entropy decoding, discarding all decoded residual information, and recording information required in encoding, wherein the marco block information required in encoding comprises a block type information, a block mode information, a motion vector information, a coded block pattern information, a quantization parameter, and a residual marco block which are required information for encoding.

5. A video transcoding system, comprising a decoder and an encoder;
the decoder, for decoding an inputting code stream by a graphical processing unit, to obtain a decoded inputting code stream;
the encoder, for analyzing the decoded inputting code stream by a central processing unit, to obtain a marco block information required in encoding; encoding the decoded inputting code stream in a target bit rate by the central processing unit according to the marco block information required in encoding.

6. The system according to claim 5, wherein:
the decoder, also for determining whether the graphical processing unit supports the decoding of the inputting code stream; if yes, acquiring a decoding capability information of the graphical processing unit; initializing a codec parameter of the graphical processing unit according to a decoding pin corresponding to the decoding capability information, and distributing memory space for the inputting code stream waiting for decoding, wherein the memory space is for saving the inputting code stream which is decoded; transmitting the inputting code stream to the graphical processing unit through a decoding pin corresponding to the decoding capability information to decode;
the encoder, also for analyzing a header information of the decoded inputting code stream by the central processing unit to obtain an entropy encoding type; entropy decoding the decoded inputting code stream, during the entropy decoding, discarding all decoded residual information, and recording information required in encoding, wherein the marco block information required in encoding includes a block type information, a block mode information, a motion vector information, a coded block pattern information, a quantization parameter, and a residual marco block which are required information for encoding.
